(19) United States
(12) Patent Application Publication
(10) Pub. No.: US 2012/0058033 A1
(43) Pub. Date: Mar. 8, 2012

(54) METHOD FOR CATALYTIC TREATING PERFLUOROCOMPOUND GAS INCLUDING PARTICLE REMOVING UNIT

(75) Inventors: Sheng-Jen YU, Hsinchu (TW); Shou-Nan LI, Hsinchu (TW); Shao-I YEN, Hsinchu (TW); Tzu-Ming CHEN, Hsinchu (TW)

(73) Assignee: Industrial Technology Research Institute, Hsinchu (TW)

(21) Appl. No.: 13/296,306

(22) Filed: Nov. 15, 2011

Related U.S. Application Data
(63) Continuation-in-part of application No. 12/078,827, filed on Apr. 7, 2008.

(30) Foreign Application Priority Data
Dec. 5, 2007 (TW) 96146244

(51) Int. Cl. B01D 53/68

(52) U.S. Cl. 423/235; 423/240 R

(57) ABSTRACT

The present invention relates to a method for treating fluoro-containing and silicon-containing gas. The method comprises treating the gas with thermal-treating, particles-treating, catalyst-treating, and acid-removing sequentially to remove perfluorocompounds. The invention achieves results of reducing the working temperature, increasing the lifetime of the catalyst, reducing the operating cost of the system, and increasing the applications of the catalyst in the aspect of fluoride-containing gas, silicon-containing gas and particles containing gas treatment by sequential treating.

### CROSS REFERENCES TO THE RELATED APPLICATIONS

This is a Continuation-in-part of U.S. application Ser. No. 12/078,827, filed on Apr. 7, 2008, which claims priority to Taiwanese Application No. 96146244, filed on Dec. 5, 2007, the entire contents of which are incorporated by reference herein.

### BACKGROUND OF THE INVENTION

1. Field of the Invention

The present invention relates to a gas treating method, more particularly a method for simultaneously treating gases containing silicon compounds and perfluorocompounds.

2. Description of Related Art

In the process of producing chips or FPDs (Flat Panel Display) in the semiconductor or optoelectronics industries, large amounts of greenhouse gases and particles are emitted. Amongst the present commercial treating equipments, including thermal, combustion and catalytic types of partial treating equipments, if perfluorocompounds (PFC) are processed only by thermal, the required operating energy cost is high. Even if in the processing of some relatively simple-processed perfluorocompounds, such as NF₃, the destruction temperature is still higher than 1000° C. For some relatively stable perfluorocompounds, such as CF₄, the removal efficiency is low, even the destruction temperature is higher than 1000° C. As for combustion type equipments, besides their high cost of fuels and low safety, large amount of CO₂ would be emitted, contributing to greenhouse effects. Catalytic type equipments can operate under low operation power. However, if deep submicron particles deposit on the surface of the catalyst, the lifetime and efficiency of the catalyst would be reduced dramatically. Therefore, catalytic type equipments can only be used for some particular processes which have low particle content.

The commercially available partial treating equipments at present which can simultaneously process exhaust gas containing perfluorocompounds, micron and deep submicron particles, Tetraethoxysilane (Si(OC₂H₅)₄), and silicon hydride (SiH₄), are mainly thermal and combustion type equipments, and their operating temperatures (thermal temperature and combustion temperature) are both higher than 1000° C. The commercially available catalytic type equipments having a operation temperature range 500 to 850° C. can remove PFC effectively, but cannot process exhaust gas containing silicon hydride, Tetraethoxysilane, and deep submicron particles.

Japanese patent JP2005111423A discloses a gas treating process. However, the heating temperature in the heating process is only between 50 to 200° C., which is not sufficient to transform silicon compounds (such as Tetraethoxysilane or SiH₄) in the gas into silicon oxide particles, and therefore cannot remove the silicon compounds in the gas by filtration but relying on other techniques.

US patent publication 2003/0049190 (referred as Irie '190 hereinafter) discloses a method for processing perfluorocarbon. The disclosed method includes transferring silicon compounds into silicon oxide particles by water or steam and then processing perfluorocarbon by using catalyst. The method intends to remove the silicon oxide particles before proceeding to the perfluorocarbon-processing procedure. However, the method may need a lot of water and it is uncertain if all the particles in the exhaust gas can interact well with the water (or steam) and be removed completely through the water. Once a significant amount of particles is remained, the pores of the catalysts used thereafter may be blocked by the particles and thereby the lifetime and efficiency of the catalyst is reduced. Furthermore, the temperature of said water or said steam taught by Irie '190 is only 100° C., which is not high enough for processing SiH₄, the most silicon component in the waste gas of CVD processes.

U.S. Pat. No. 5,800,792 (referred as Ibaraki '792 hereinafter) teaches another way to process silicon compounds. The silicon compounds are oxidized by heat and removed by bag filtration. In fact, as mentioned before, it is well-known in the art that SiH₄ accounts for the most part (about 0.1%˜10% (1,000 ppmv˜100,000 ppmv)) in the waste gas of CVD processes and silicon oxide particles resulting from the oxidization of SiH₄ have a wide distribution of particle size (1 nm˜10000 nm). According to the limitation of filtration ability of bag filtration disclosed by Pui et al., (Journal of Nanoparticle Research (2007) 9:117-125), bag filtration cannot properly remove the particles resulting from the oxidization of SiH₄. Therefore, it is of high chance that if the method taught by Ibaraki '792 is incorporated for processing exhaust gas with perfluorocarbon, the remained particles after bag filtration may block the pores of catalysts and reduce the lifetime and efficacy thereof.

Therefore, the target of this field is to develop a method, which has simple processing steps, low energy consumption, and would be able to process a wide range of gases.

### SUMMARY OF THE INVENTION

In view of the disadvantages in the known art, the object of the present invention is to provide an industrial process, such as exhaust gas treatment in semiconductor and optoelectronics industries, to reduce the operation energy consumption and increase the lifetime of catalyst.

In order to achieve the above object, the present invention provides a method for catalytically treating a gas containing silicon hydride at a concentration of 1,000 ppmv˜100,000 ppmv and perfluorocompounds, including a particle removing unit, comprising the steps of: (a) thermal-treating both fluoro-containing and silicon hydride-containing gas; (b) particle-treating the gas after thermal-treating to remove particles large than 1 nm in the gas by using a wet electrostatic precipitator with condensation-growth chamber; (e) catalyst-treating the gas after particle-treating in step (b) by contacting with catalyst; and (d) removing acids in the gas after catalyst-treating, wherein the above steps are operated at a temperature of 350 to 800° C.

The present invention uses separate solid and gas treating processes, which is not limited to the processing of fluoro-containing gas, but also can be used to process exhaust gases containing perfluorocompounds, micron and deep submicron particles, silanes, and oxysilanessiliconin manufacturing processes of semiconductor or optoelectronics industries, and the temperature of thermal-treating is lower than that of a process which uses single thermal-treating alone to remove fluoro-containing compound.

### BRIEF DESCRIPTION OF THE DRAWINGS

FIG. 1 is the flowchart of gas treating method of the present invention.

FIG. 2 is a sectional view of a wet electrostatic precipitator with a condensation-growth chamber.

FIG. 3 shows the removal efficiency of the wet electrostatic precipitator showed in FIG. 2.

FIG. 4 shows the removal efficiency of a conventional wet electrostatic precipitator.

FIG. 5 shows the aerosol penetration of the wet electrostatic precipitator showed in FIG. 2 for particles <40 nm.

FIG. 6 shows the aerosol penetration of a conventional wet electrostatic precipitator for particles <40 nm.

FIG. 7 is the trend plot of removing particles by the method of the present invention.

FIG. 8 is the trend plot of removing SiH₄ by the method of the present invention.

FIG. 9 is the trend plot of removing NF₃ by the method of the present invention.

FIG. 10 is the trend plot of removing SF₆ by the method of the present invention.

### DETAILED DESCRIPTION OF THE INVENTION

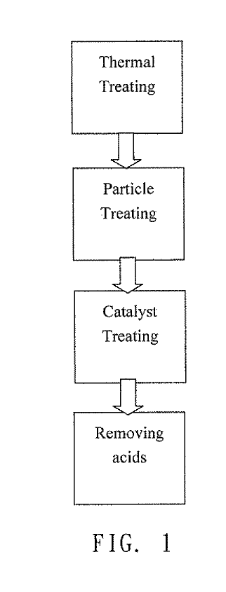

The flowchart of the method of the present invention is shown in FIG. 1, which processes the fluoro-containing and silicon-containing gas by the following steps sequentially: thermal-treating, which is to process the gas at a temperature of 350 to 800° C.; particle-treating the gas to remove particles large than 1 nm; catalyst-treating, which is to process the gas at a temperature of 350 to 800° C.; and acid removal.

The condition of providing the thermal-treating temperature of 350 to 800° C. necessary for the present invention can be fulfilled by methods including combustion heating, thermal couple heating, microwave heating etc. The thermal-treating process of the present invention would be able to oxidize the silicon compounds (such as Tetraethoxysilane or silicon hydride) in the processing gas into silicon oxide particles.

The particle-treating step is used to filter the silicon oxide particles, which is originally contained in the gas to be processed or produced during the thermal-treating step. The applicable particle-treating includes bag filtration, wet electrostatic precipitation, water-washing, gravity settling or inertial impact. The purpose of particle-treating is to pre-process the gas before the following catalyst-treating, avoid particles depositing on the surface of catalyst support which will reduce the efficacy of the catalyst.

Besides the thermal-treating and particle-treating to remove silicon compounds, the other object is to connect thermal-treating and particle-treating as the pre-processing for catalytic-treating. Catalytic-treating is to react fluoro-containing gas via catalytic reaction to form hydrofluoric acid. The fluoro-containing gas mentioned in the present invention includes perfluorocompounds (PFC), which can be further divided into fluoro-nitrogen compounds (such as NF₃), fluorocarbon compounds (such as CF₄ or CHF₃) and fluoro-sulfur compounds (such as SF₆). The suitable catalyst for the catalytic-treating can be any catalyst used for processing fluoro-containing gas in the known art, especially the two-stage type catalyst in the other application (US Publication No.: 2009/0155154) of the present applicant (said catalyst is prepared in two stages; wherein the first stage is for coating Al₂O₃-based zinc, and the second stage is for coating Al₂O₃-based copper and cerium), which is used to decompose fluoro-containing compounds. The operation temperature for a catalyst to decompose fluoro-containing compounds depends on the property of the catalyst itself or that of the fluoro-containing compounds in the processing gas. For example, the two-stage type catalyst in the other application, the decomposing temperature for SF₆ is about 580° C., 350° C. for NF₃, and 800° C. for the relatively stable CF₄.

It can be easily understood that each step of the method of the present invention can have their respective operation temperatures, but they also can be operated under the same operation temperature. One of the differences between prior art and the present invention is: the thermal-treating of the present invention is not used to process fluoro-containing gas, but to transform silicon-containing compound into silicon oxide. Therefore, the operation temperature of the present method is only 400 to 600° C. process gases coming through, while processes using electro-heating or microwave-heating or combustion-heating to decompose fluoro-containing compound require temperatures higher than 1000° C.

Generally speaking, it is not required to limit the gas exhaust in the method of the present invention, because the processing capability of each step can be changed depending on the volume of the gas to be processed as needed. However, in a general embodiment, in order to consider both the processing rate and the completeness of the reaction, gas flow rate of the present invention should be set at 10 to 500 liter per hour, preferably 30 to 250 liter per hour.

In the end, the fluoro-containing compound after catalytic-treating is transformed into hydrofluoric acid, and then the hydrofluoric acid is removed by an acid removal step. Generally speaking, the removal step is carried out and completed by water-washing. Besides the hydrofluoric acid formed by fluoro-containing compounds, other acids in the gas, including but not limited to hydrochloric acid and hydrobromic acid, are the compounds to be removed in the acid removal step. Therefore, other techniques with the same acid removal objectives are not excluded.

Accordingly, it is noted that to better appreciate the drawbacks or insufficiency of the conventional method for processing exhaust gas in the art, the method of the present invention does not need high temperature for heat-treating. However, if the exhaust gas to be processed contains SiH₄ at a concentration of 1,000 ppmv˜100,000 ppmv, the performance of conventional filtration methods such as bag filtration and wet electrostatic precipitation may not be enough to remove particles (SiO₂ particles resulted from oxidation of SiH₄) with such wide distribution of sizes. U.S. Pat. No. 7,833,324, another invention of the inventor of the present invention, discloses an improved wet electrostatic precipitator. The improved wet electrostatic precipitator of U.S. Pat. No. 7,833,324 is discussed briefly in the following paragraphs.

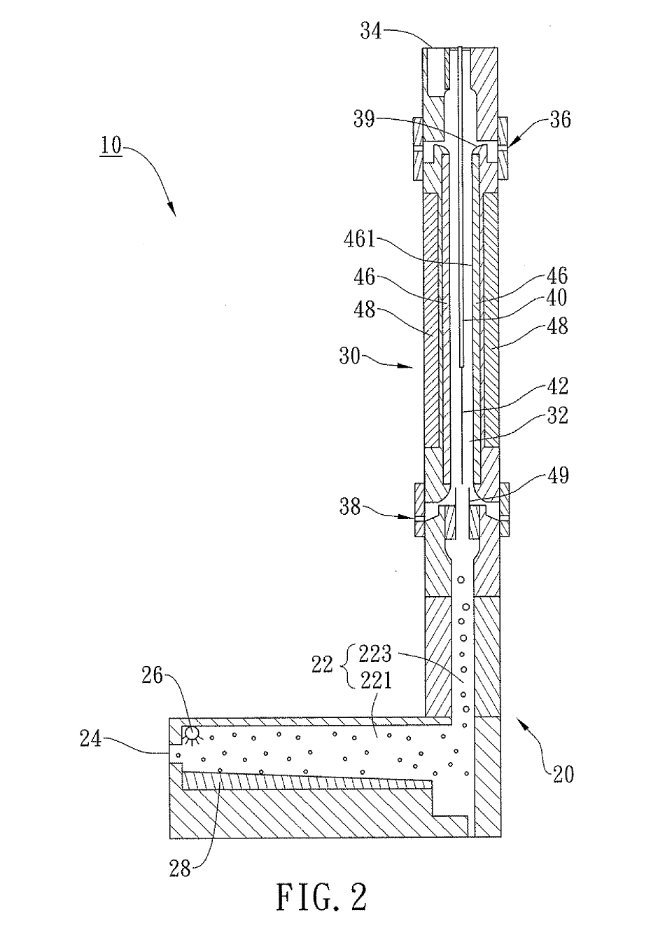

Please refer to FIG. 2. The improved wet electrostatic precipitator 10 comprises a condensation chamber 20, a nebulizer 26, a heater 28, a precipitation chamber 30, three dual-sleeve member 40, three discharge electrodes 42, three ultrasonic vibrators (not shown), two insulating members 46, two ground electrodes 48 and two baffles 49.

The nebulizer 26 is mounted inside the condensation-growth chamber 20 near the waste gas inlet 24 and adapted for spraying a water mist toward the heating region 221 of the condensation-growth chamber 20 to enhance the humility to a saturated status. The heater 28 is mounted in the condensation-growth chamber 20 at the bottom side of the heating region 221 of the first enclosed cavity 22. The waste gas to be treated is guided through the waste gas inlet 24 into the heating region 221 of the first enclosed cavity 22 where the waste gas is heated by the heater 28. At the same time, the water mist sprayed by the nebulizer 26 is vaporized and mixed with the waste gas. Thereafter, the waste gas and the steam enter the cooling region 223 and are cooling down. Following dropping of temperature, the steam in the cooling region 223 will become over-saturated and condensed on the surface of the particles in the waste gas, causing the particles to grow.

The precipitation chamber 30 comprises a second enclosed cavity 32, a gas outlet 34, two liquid intake passages 36, two liquid return passages 38 and two chamfers 39. The second enclosed cavity 32 is in communication with the cooling region 223 of the first enclosed cavity 32. The gas outlet 34, the liquid intake passages 36 and the liquid return passages 38 are respectively extended from the second enclosed cavity 32 to the outside of the precipitation chamber 30.

The insulating members 46 are made of glass in the shape of a rectangular plate and arranged on the wall surface of the second enclosed cavity 32 of the precipitation chamber 30. The two insulating members 46 are arranged at two opposite sides relative to the discharge electrodes 42 under the liquid intake passages 36, each having a coarse surface 461 formed through a sand blast treatment. Further, the coarse surface 461 may be coated with a layer of titanium dioxide coating and radiated with ultraviolet light to cause a photocatalytic reaction so that the coarse surface 461 can form a hydrophilic surface. The two ground electrodes 48 are mounted on the outer wall surface of the precipitation chamber 30 on the outside of the two insulating members 46. The discharge electrodes 42 and the ground electrodes 48 are respectively connected to a high voltage DC power source (not shown) so that an electric field is formed between the discharge electrodes 42 and the ground electrodes 48. The two baffles 49 are respectively mounted on the inner wall surface of the precipitation chamber 30 between the second enclosed cavity 32 and the two liquid return passages 38 to smoothen flow of the cleaning fluid into the two liquid return passages 38.

When the high voltage DC power source is providing a high voltage direct current to cause an electric field between the discharge electrodes 42 and the ground electrodes 48, the discharge electrodes 42 generate corona discharge, causing the particles in the waste gas to be charged and to move toward the insulating members 46. At the same time, the cleaning fluid goes through the liquid intake passages 36 and chamfers 39 of the precipitation chamber 30 into the second enclosed cavity 32, and then flows downwards along the surfaces 461 of the insulating members 46 in the form of a water film to wash away the charged particles from the waste gas before touching the insulating members 46, purifying the waste gas. The purified gas is then expelled to the outside through the gas outlet 34.

Because the particles in the waste gas are designed to grow in the condensation-growth chamber of the wet electrostatic precipitator 10 and then washed away after the particle size thereof is increased, the collection efficiency of deep-submicron particles is effectively enhanced. Also, the coarse surface 461 of each insulating member 46 is a hydrophilic surface, facilitating the formation of a uniform water film on the coarse surface 461 with the cleaning fluid for washing away the particles from the waste gas. In addition, the insulating members 46 are made of a non-conducting material and set between the discharge electrodes 42 and the ground electrodes 48, avoiding a short circuit or sparks during flowing of the cleaning fluid and enhancing safe use.

The inventor surprisedly finds that the aforesaid improved wet electrostatic precipitator is able to perform the required filtration ability for the process of the present invention. Therefore, in order to complete the ability of processing waste gas and fulfill the object of the present invention, U.S. Pat. No. 7,833,324 is incorporated into the present invention as a whole.

The advantages of the present invention are further depicted with the illustration of examples, which however should not be construed as a limitation of the scope of the claims.

### Example 1

### Test the Filtering Performance of the Wet Electrostatic Precipitator with Condensation-Growth Chamber

It is noted that conventional bag filtration fail to perform sufficient filtration ability for submicron particles or nano-particles (Pui et al., Journal of Nanoparticle Research (2007) 9:117-125). Here we tested the filtration performance of the aforesaid wet electrostatic precipitator with condensation-growth chamber.

Steps of the experiment are briefly described as follows. SiH₄ is applied in to an electrical heating chamber from a standard gases cylinder and heated at 350° C. for effectively oxidizing SiH₄ into solid particles of SiO₂. The processed gas contains particles of is then introduced into an aforesaid wet electrostatic precipitator with condensation-growth chamber. An electrical low pressure impactor (ELPI) is configured behind the wet electrostatic precipitator for determining the filtration efficiency thereof. The filtration efficiency is displayed as removal efficiency (RE) and aerosol penetration. Removal efficiency represents the difference between the “Inlet” the “Outlet” of particle total number counted; and aerosol penetration is calculated as the formula of “100%−RE”.

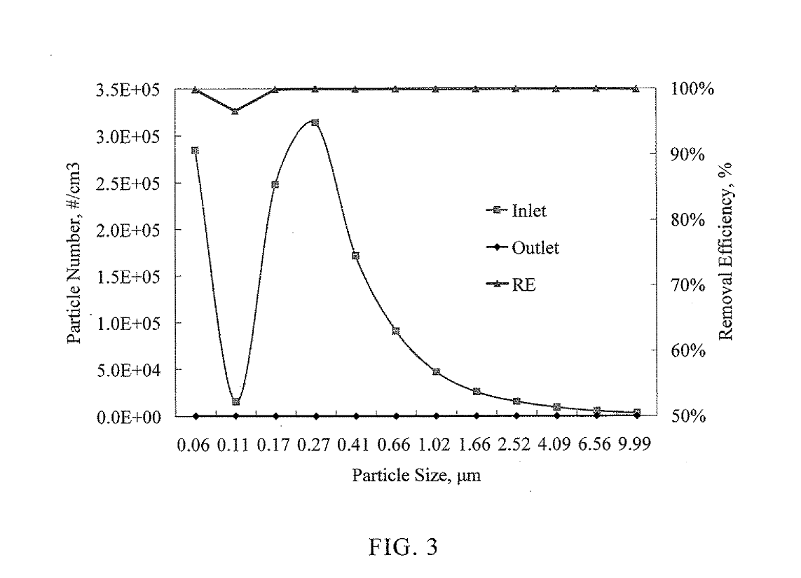

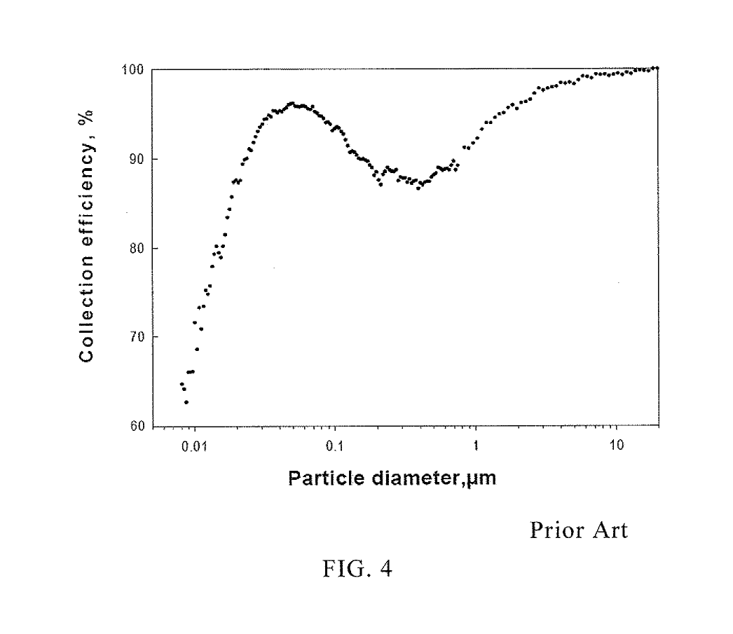

The result is showed in FIG. 3. According to the result, the aforesaid wet electrostatic precipitator with condensation-growth chamber performed excellent collection efficiency even for particles with diameter less than 10 nm; wherein the “RE” represents “Removal Efficiency” as defined in the previous paragraph. In comparison with the performance of a conventional wet electrostatic precipitator showed in FIG. 4(Huang et al., Environ. Sci. Technol. 2002, 36, 4625-4632), which fails to perform sufficient filtration ability for particles with diameter less than 10 nm, the aforesaid wet electrostatic precipitator with condensation-growth chamber is deemed suitable for the process of the present invention.

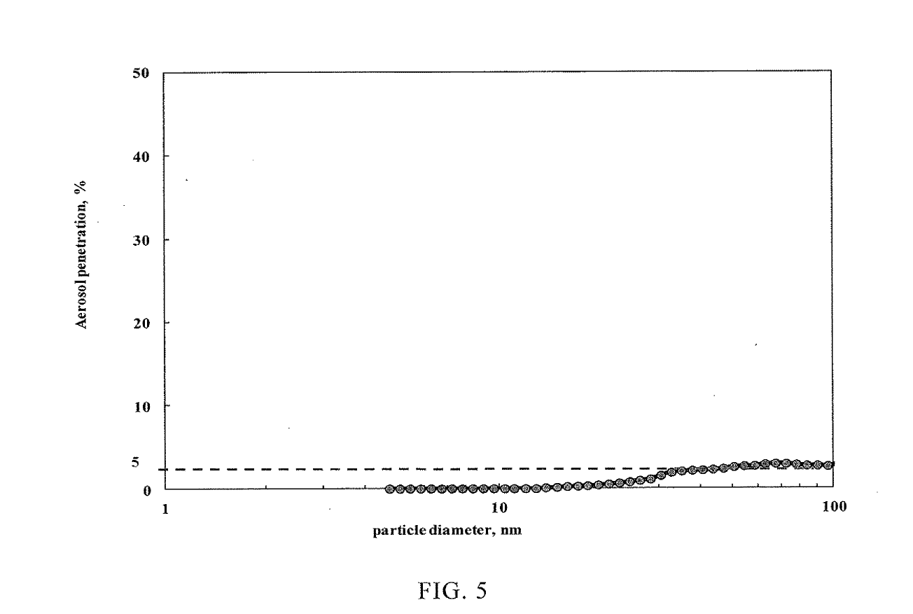

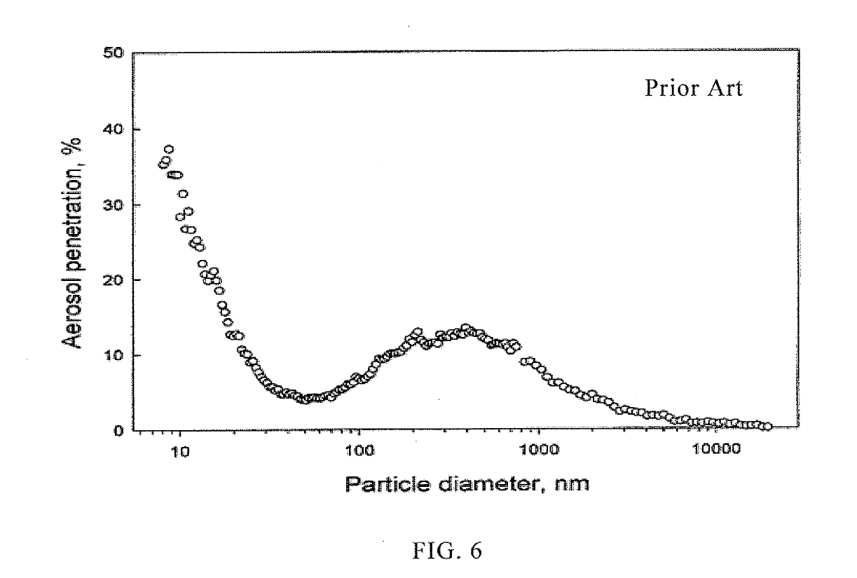

Furthermore, the aerosol penetration of particles smaller than 40 nm of the aforesaid wet electrostatic precipitator with condensation-growth chamber and a conventional wet electrostatic precipitator (Huang et al., Environ. Sci. Technol. 2002, 36, 4625-4632) is also showed (FIGS. 5 and 6). The aerosol penetration of the aforesaid wet electrostatic precipitator with condensation-growth chamber is about 0.5%; whereas, that of the conventional wet electrostatic precipitator is 14.8%. It is clear that the aforesaid wet electrostatic precipitator with condensation-growth chamber has significantly better performance than the conventional one for filtering particles smaller than 40 nm.

### Example 2

### Efficacy of the Gas Treating System of the Present Invention

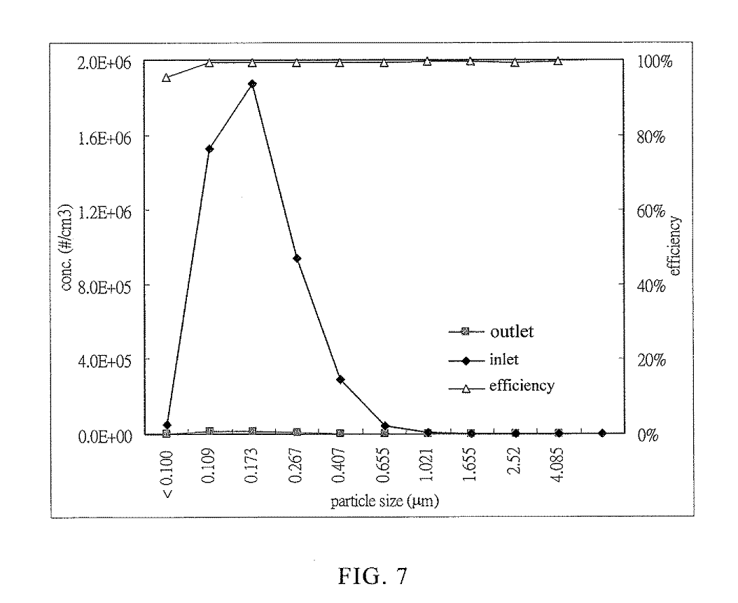

The present example tested from process exhaust gases included about 1,000 ppm NF₃(/SF₆) and about 3,000 ppm SiH₄ to analyze the efficacy of the system, wherein the highest operation temperature is lower than 550° C. (SF₆: 580° C.), the flow rate is 44˜295 lpm (L/min), and the catalyst is the aforementioned two-stage type catalyst. Testing results are shown in FIG. 7 to FIG. 10. FIG. 7 is a trend plot of particle removing when SiH₄ is provided as testing gas before and after particle-treating (wet electrostatic precipitator with condensation-growth chamber). It is known from the plot that when size of the particle (SiO₂) is distributed between <0.01 μm to 4.085 μm, the removal efficiency is about 99%, which is consistent with the high performance showed in the experimental results of embodiment 1.

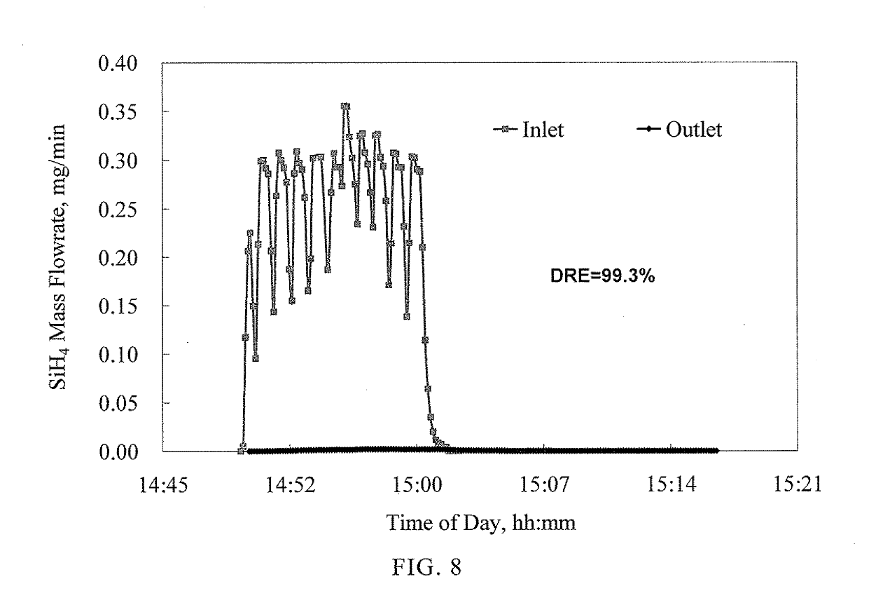

FIG. 8 is a removing trend plot of for SiH₄ before and after thermal-treating (thermal couple heating); wherein the destruction temperature is 350° C.

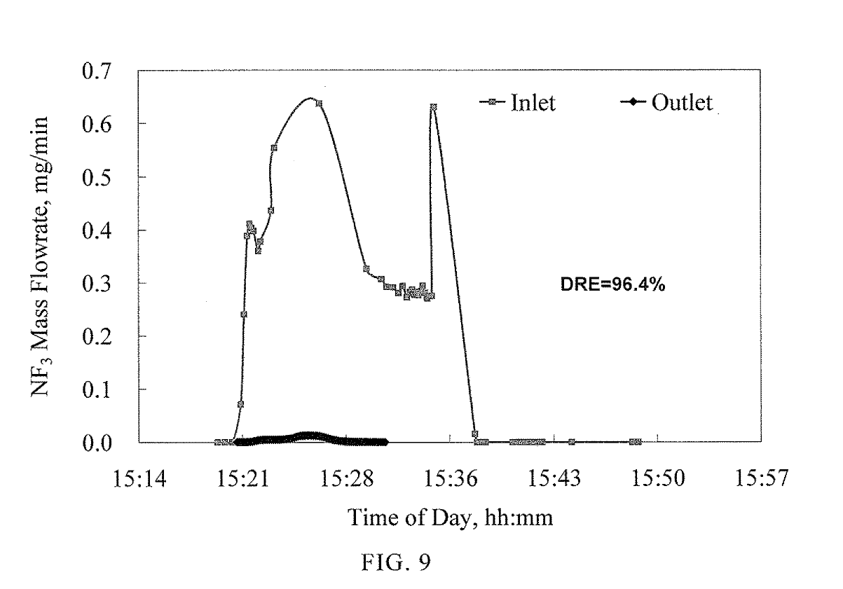

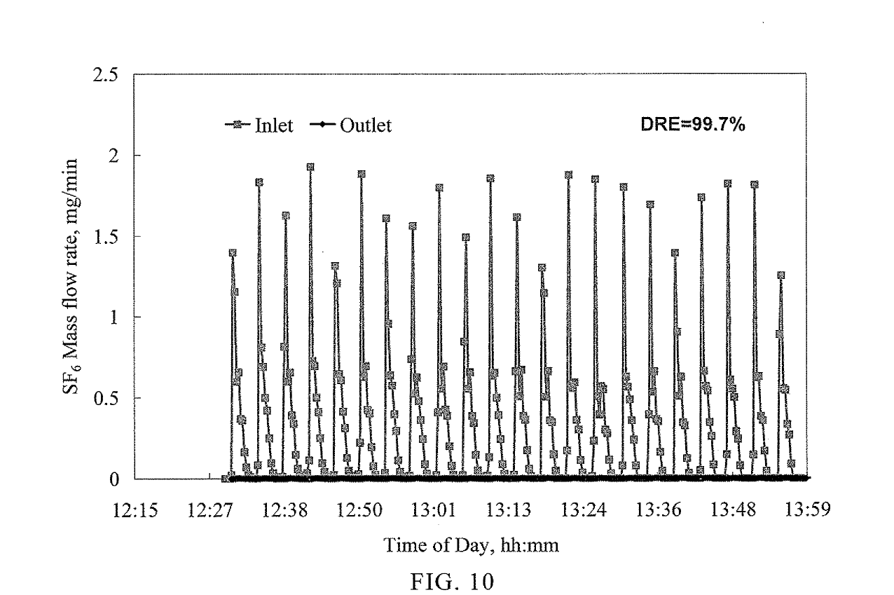

FIG. 9 and FIG. 10 are the removal efficacies when NF₃ and SF₆ are provided from process in the system of present invention. For catalyst used, the testing time for NF₃ is 6 to 8 hours every day, and testing temperature is 350° C.; the testing time for SF₆ is two days in a row, and testing temperature is 580° C. It is known from the plot, the removal efficiencies for NF₃ and SF₆ both achieved percentages higher than 95%.

In summary, the method of the present invention integrates thermal-treating, particle-treating, catalytic-treating and acid removal steps. As demonstrated by experiments, the method of the present invention can effectively remove the gas containing SiH₄ and fluoro-compound such as SF₆/NF₃ at a operation temperature of 350 to 800° C., and the removal efficiency is higher than 95% (catalyst operation temperature: SF₆/580° C. and NF₃/350° C.; thermal-treating temperature: 400 to 550° C.). Therefore, the present invention is characterized by the innovation of integrating different kinds of treating methods (thermal-treating, micron and deep submicron particle-treating, catalytic-treating and acid removal), as well as removing SiH₄ and perfluorocompounds in different steps. Furthermore, the method of the present invention can simultaneously process flue gas containing SiH₄, TEOS, deep submicron particles and perfluorocompounds, and the overall operation temperature is lower than that of commercially available products targeting the same function, and the operation range of particle size is wider than that of the embodiments of other inventions.

### Other Examples

All technical features disclosed in this specification can be combined with other processes, and every single technical feature can be selectively substituted by features the same with, equal to, or similar to the aimed features. Therefore, each technical feature disclosed in this specification is merely an example equal to or similar to the aimed features.

The preferred embodiments of the present invention have been disclosed above, but these embodiments are not used to limit the present invention. Those skilled in the art can make various changes and modifications without departing the spirit of the present invention.

What is claimed is:

1. A method for catalytically treating a gas containing silicon hydride at a concentration of 1,000 ppmv˜100,000 ppmv and perfluorocompounds, including a particle removing unit, comprising the steps of:
(a) thermal-treating both fluoro-containing and silicon hydride (SiH₄)— containing gas;
(b) particle-treating the gas after said thermal-treating to remove particles large than 1 nm in the gas by using a wet electrostatic precipitator with condensation-growth chamber;
(c) catalyst-treating the gas after the particle-treating in step (b) by contacting with catalyst; and
(d) removing acids after the catalytically treated gas;
wherein above steps are carried out in 350 to 800° C.

2. The method according to claim 1, wherein said thermal-treating includes combustion heating, thermal couple heating or microwave heating.

3. The method according to claim 1, wherein said thermal-treating is used to oxidize silicon hydride into particles.

4. The method according to claim 1, wherein said fluoro-containing gas includes fluoro-hydrocarbon compounds, fluoro-nitrogen compounds or fluoro-sulfur compounds or mixtures thereof.

5. The method according to claim 1, wherein said thermal-treating is to process the gas at a temperature of 400 to 550° C.

6. The method according to claim 1, wherein said acid in step (d) is removed by water-washing.

7. The method according to claim 1, wherein said acid in step (d) includes hydrofluoric acid, hydrochloric acid, or hydrobromic acid.

8. The method according to claim 1, wherein said wet electrostatic precipitator comprises:
a condensation-growth chamber, said condensation-growth chamber comprising a first enclosed cavity and a waste gas inlet, said waste gas inlet extending from said first enclosed cavity to the outside of said condensation-growth chamber;
a precipitation chamber, said precipitation chamber comprising a second enclosed cavity, a gas outlet, at least one liquid intake passage and at least one liquid return passage, said second enclosed cavity being in communication with said first enclosed cavity, said gas outlet and said at least one liquid intake passage and said at least one liquid return passage extending from said second enclosed cavity to the outside of said precipitation chamber;
at least one discharge electrode mounted in said second enclosed cavity of said precipitation chamber;
at least one insulating member made of a non-conducting material and arranged on the inner wall of said precipitation chamber below said at least one liquid intake passage; and
at least one ground electrode mounted on said precipitation chamber at an outer side relative to said at least one insulating member.
